(19) United States
(12) Patent Application Publication
(10) Pub. No.: US 2024/0129092 A1
(43) Pub. Date: Apr. 18, 2024

(54) CHANNEL STATE INFORMATION FEEDBACK METHOD AND APPARATUS

(71) Applicant: HUAWEI TECHNOLOGIES CO., LTD., Shenzhen (CN)

(72) Inventors: Junhui GAO, Shanghai (CN); Huangping JIN, Shanghai (CN); Xiang REN, Boulogne Billancourt (FR)

(21) Appl. No.: 18/541,093

(22) Filed: Dec. 15, 2023

Related U.S. Application Data
(63) Continuation of application No. PCT/CN2022/095178, filed on May 26, 2022.

(30) Foreign Application Priority Data
Jun. 16, 2021 (CN) 202110664838.0

(51) Int. Cl. H04L 5/00; H04B 7/06

(52) U.S. Cl. CPC H04L 5/0051; H04B 7/0626

(57) ABSTRACT

A channel state information (CSI) feedback method and apparatus. A terminal device receives a channel state information reference signal (CSI-RS) from a network device, and performs channel sounding based on the CSI-RS. The terminal device feeds back CSI to the network device based on a first codebook, wherein the first codebook is determined based on one or more transmit-end space-domain and frequency-domain column vectors and one or more receive-end space-domain and time-domain column vectors that represent a channel Alternatively, the first codebook is determined based on the one or more transmit-end space-domain and frequency-domain column vectors and one or more time-domain column vectors that represent the channel.

### CROSS-REFERENCE TO RELATED APPLICATIONS

This application is a continuation of International Application No. PCT/CN2022/095178, filed on May 26, 2022, which claims priority to Chinese Patent Application No. 202110664838.0, filed on Jun. 16, 2021. The disclosures of the aforementioned applications are hereby incorporated by reference in their entireties.

### BACKGROUND

A 5th generation (5G) communications system has higher goals in aspects such as a system capacity and spectral efficiency. In a 5G communications system, a massive multiple input multiple output (MIMO) technology plays a critical role in spectral efficiency of the system. In response to a MIMO technology being used, a network device performs modulation and coding and signal precoding in response to the network device sending data to a terminal device. How the network device sends the data to the terminal device depends on channel state information (CSI) fed back by the terminal device to the network device. Therefore, accuracy of the CSI plays a very important role in system performance

In an actual system, there is a delay in CSI feedback, and consequently, CSI obtained by a network device has an expiration problem. To be specific, there is a delay between the CSI that is fed back by a terminal device and that is obtained by the network device and CSI of a current actual channel. As a result, precoding that is used for data sending and that is obtained through calculation by the network device based on the CSI fed back by the terminal device does not match precoding corresponding to the current actual channel This causes system performance degradation.

### SUMMARY

Embodiments described herein provide a channel state information feedback method and apparatus, to resolve a problem that system performance is poor because fed-back CSI is inaccurate due to CSI expiration in a conventional technology.

According to a first aspect, at least one embodiment provides a channel state information feedback method. The method includes: A terminal device receives a channel state information reference signal (CSI-RS) from a network device, and performs channel sounding based on the CSI-RS; and then the terminal device feeds back channel state information (CSI) to the network device based on a first codebook, where the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

According to the method, the terminal device describes a time-varying characteristic of the channel by using the channel state information fed back based on the first codebook that includes Doppler information (that is, time-domain information). Changing of the Doppler information is slow within short sounding duration. Therefore, the network device reconstructs, based on the first codebook, a channel present within sounding duration, predict a future channel change trend based on a time-varying trend of the reconstructed channel, and calculate a downlink precoding matrix based on a predicted channel to better match a current channel, thereby improving system performance In addition, transmit-end space-domain and frequency-domain combined and receive-end space-domain and time-domain combined bases are constructed, so that channel projection sparsity is increased, thereby reducing feedback overheads. The channel state information is fed back in four dimensions, namely, a transmit end, a frequency domain, a receive end, and a time domain, or in three dimensions, namely, a transmit end, a frequency domain, and a time domain, so that a channel characteristic is represented more precisely. Therefore, the network device performs channel prediction more accurately based on the channel state information fed back by the terminal device.

In at least one embodiment, the first codebook meets the following formula: W=W₁W₂W₃^{H},where W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix. In this way, the transmit-end space-domain and frequency-domain combined and receive-end space-domain and time-domain combined bases are constructed, so that channel projection sparsity is increased, thereby reducing feedback overheads. The channel state information is fed back in four dimensions, namely, the transmit end, the frequency domain, the receive end, and the time domain, so that the channel characteristic is represented more precisely, and further, the network device performs channel prediction more accurately based on the channel state information fed back by the terminal device.

In at least one embodiment, the first codebook meets the following formula: W=W₁ W₄ W₅^{H}, where W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix. In this way, the transmit-end space-domain and frequency-domain combined and receive-end space-domain and time-domain combined bases are constructed, so that channel projection sparsity is increased, thereby reducing feedback overheads. The channel state information is fed back in three dimensions, namely, the transmit end, the frequency domain, and the time domain, so that the channel characteristic is represented more precisely, and further, the network device performs channel prediction more accurately based on the channel state information fed back by the terminal device.

In at least one embodiment, the transmit-end space-domain and frequency-domain combined base matrix W₁ meets the following formula: W₁=W₁₁W₁₂, where W₁₁ is a transmit end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS. According to the method, joint compression in the transmit-end space domain and frequency domain increases sparsity of a projection coefficient of the channel for the transmit-end space-domain and frequency-domain combined base matrix, thereby reducing feedback overheads.

In at least one embodiment, the receive-end space-domain and time-domain combined base matrix W₃ meets the following formula: W₃=W₃₁ W₃₂, where W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and the sounding duration. According to the method, joint compression in the receive-end space domain and time domain increases sparsity of projection of the channel for the receive-end space-domain and time-domain combined base matrix to a specific extent, thereby reducing feedback overheads.

In at least one embodiment, one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

In at least one embodiment, W₁₁ meets the following formula: W₁₁=W_{f}*⊗Wₜₓ, where W_{f}* is a conjugate matrix of W_{f}, W_{f} indicates a frequency-domain basic base, and Wₜₓ indicates a transmit-end space-domain basic base.

In at least one embodiment, one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases.

In at least one embodiment, W₃₁ meets the following formula: W₃₁=Wₜ*⊗Wᵣₓ, where Wₜ* is a conjugate matrix of Wₜ, Wₜ indicates a time-domain basic base, and Wᵣₓ indicates a receive-end space-domain basic base.

In at least one embodiment, a dimension of W₂ is L*N₁, L represents a selected quantity of transmit-end space-domain and frequency-domain combined bases, L is a value preconfigured or predefined by the network device, N₁ represents a selected quantity of receive-end space-domain and time-domain combined bases, and N₁ is a value preconfigured or predefined by the network device. In this way, codebook compression in four dimensions, namely, the transmit-end space domain, the frequency domain, the receive-end space domain, and the time domain, is implemented, so that channel information is fed back more accurately in the four dimensions for channel change prediction, and feedback overheads are also reduced.

In at least one embodiment, a dimension of W₄ is L*N_{d}, L represents a selected quantity of transmit-end space-domain and frequency-domain combined bases, L is a value preconfigured or predefined by the network device, and N_{d} represents the sounding duration. In this way, codebook feedback in three dimensions, namely, the transmit-end space domain, the frequency domain, and the time domain, is implemented for channel change prediction; moreover, the receive-end space domain dimension is removed, so that a quantity of feedback coefficients is reduced, thereby reducing feedback overheads.

In at least one embodiment, a feedback period of the transmit-end space-domain and frequency-domain combined basic base correction matrix W₁₂ is T1, T1 is a value preconfigured or predefined by the network device, T1 is greater than a period of feeding back first information, and the first information is information that is in the CSI and that is other than information fed back based on W₁₂. For example, the first information includes but is not limited to a base complex coefficient matrix. According to the method, the terminal device feeds back the transmit-end space-domain and frequency-domain combined basic base correction matrix based on the longer period, and feeds back the base complex coefficient matrix based on the shorter period, to reduce feedback overheads.

In at least one embodiment, the terminal device receives second information from the network device, where the second information indicates a codebook type used by the terminal device for channel sounding. In this way, the terminal device and the network device know the used codebook type in advance, to feed back the channel state information based on a codebook of the codebook type.

According to a second aspect, at least one embodiment provides a channel state information feedback method. The method includes: A network device sends a channel state information reference signal CSI-RS to a terminal device, and the network device receives channel state information CSI that is fed back by the terminal device based on a first codebook, where the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

According to the method, the terminal device describes a time-varying characteristic of the channel by using the channel state information fed back based on the first codebook that includes Doppler information (that is, time-domain information). Changing of the Doppler information is slow within short sounding duration. Therefore, the network device reconstructs, based on the first codebook, a channel present within sounding duration, predict a future channel change trend based on a time-varying trend of the reconstructed channel, and calculate a downlink precoding matrix based on a predicted channel to better match a current channel, thereby improving system performance In addition, transmit-end space-domain and frequency-domain combined and receive-end space-domain and time-domain combined bases are constructed, so that channel projection sparsity is increased, thereby reducing feedback overheads. The channel state information is fed back in four dimensions, namely, a transmit end, a frequency domain, a receive end, and a time domain, or in three dimensions, namely, a transmit end, a frequency domain, and a time domain, so that a channel characteristic is represented more precisely. Therefore, the network device performs channel prediction more accurately based on the channel state information fed back by the terminal device.

In at least one embodiment, the first codebook meets the following formula: W=W₁W₂W₃^{H}, where W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix. In this way, the transmit-end space-domain and frequency-domain combined and receive-end space-domain and time-domain combined bases are constructed, so that channel projection sparsity is increased, thereby reducing feedback overheads. The channel state information is fed back in four dimensions, namely, the transmit end, the frequency domain, the receive end, and the time domain, so that the channel characteristic is represented more precisely, and further, the network device performs channel prediction more accurately based on the channel state information fed back by the terminal device.

In at least one embodiment, the first codebook meets the following formula: W=W₁ W₄ W₅^{H}, where W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix. In this way, the transmit-end space-domain and frequency-domain combined and receive-end space-domain and time-domain combined bases are constructed, so that channel projection sparsity is increased, thereby reducing feedback overheads. The channel state information is fed back in three dimensions, namely, the transmit end, the frequency domain, and the time domain, so that the channel characteristic is represented more precisely, and further, the network device performs channel prediction more accurately based on the channel state information fed back by the terminal device.

In at least one embodiment, the transmit-end space-domain and frequency-domain combined base matrix W₁ meets the following formula: W₁=W₁₁W₁₂, where W₁₁ is a transmit end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS. According to the method, joint compression in the transmit-end space domain and frequency domain increases sparsity of a projection coefficient of the channel for the transmit-end space-domain and frequency-domain combined base matrix, thereby reducing feedback overheads.

In at least one embodiment, the receive-end space-domain and time-domain combined base matrix W₃ meets the following formula: W₃=W₃₁ W₃₂, where W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and the sounding duration. According to the method, joint compression in the receive-end space domain and time domain increases sparsity of projection of the channel for the receive-end space-domain and time-domain combined base matrix to a specific extent, thereby reducing feedback overheads.

In at least one embodiment, one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

In at least one embodiment, W₁₁ meets the following formula: W₁₁=W_{f}*⊗Wₜₓ, where W_{f}* is a conjugate matrix of W_{f}, W_{f} indicates a frequency-domain basic base, and Wₜₓ indicates a transmit-end space-domain basic base.

In at least one embodiment, one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases.

In at least one embodiment, W₃₁ meets the following formula: W₃₁=Wₜ*⊗Wᵣₓ, where Wₜ* is a conjugate matrix of WₜWₜindicates a time-domain basic base, and Wᵣₓ indicates a receive-end space-domain basic base.

In at least one embodiment, a dimension of W₂ is L*N₁, L represents a selected quantity of transmit-end space-domain and frequency-domain combined bases, L is a value preconfigured or predefined by the network device, N₁ represents a selected quantity of receive-end space-domain and time-domain combined bases, and N₁ is a value preconfigured or predefined by the network device. In this way, codebook compression in four dimensions, namely, the transmit-end space domain, the frequency domain, the receive-end space domain, and the time domain, is implemented, so that channel information is fed back more accurately in the four l dimensions for channel change prediction, and feedback overheads are also reduced.

In at least one embodiment, a dimension of W₄ is L*N_{d}, L represents a selected quantity of transmit-end space-domain and frequency-domain combined bases, L is a value preconfigured or predefined by the network device, and N_{d} represents the sounding duration. In this way, codebook feedback in three dimensions, namely, the transmit-end space domain, the frequency domain, and the time domain, is implemented for channel change prediction; moreover, the receive-end space domain dimension is removed, so that a quantity of feedback coefficients is reduced, thereby reducing feedback overheads.

In at least one embodiment, a feedback period of the transmit-end space-domain and frequency-domain combined basic base correction matrix W₁₂ is T1, T1 is a value preconfigured or predefined by the network device, T1 is greater than a period of feeding back first information, and the first information is information that is in the CSI and that is other than information fed back based on W₁₂. For example, the first information includes but is not limited to a base complex coefficient matrix. According to the method, the terminal device feeds back the transmit-end space-domain and frequency-domain combined basic base correction matrix based on the longer period, and feeds back the base complex coefficient matrix based on the shorter period, to reduce feedback overheads.

In at least one embodiment, the network device sends second information to the terminal device, where the second information indicates a codebook type used by the terminal device for channel sounding. In this way, the terminal device and the network device know the used codebook type in advance, to feed back the channel state information based on a codebook of the codebook type.

According to a third aspect, at least one embodiment provides a channel state information feedback method. The method includes: A terminal device receives a CSI-RS from a network device, and performs channel sounding based on the CSI-RS; and then the terminal device feeds back channel state information to the network device, where the channel state information indicates one or more first bases, and the one or more first bases are used to generate, based on a preset base generation method, one or more second bases indicating the channel state information. In this way, a base of the terminal device is aligned with a base of the network device, so that channel reconstruction and precoding is performed more accurately, thereby improving system performance

In at least one embodiment, the one or more first bases are one or more space-domain and frequency-domain combined statistical covariance base column vectors obtained through quantization.

In at least one embodiment, the preset base generation method is an orthogonalization method preconfigured or predefined by the network device. In this way, the aligned bases of the terminal device and the network device is obtained accurately by using the orthogonalization method preconfigured or predefined by the network device.

According to a fourth aspect, at least one embodiment provides a channel state information feedback method. The method includes: A network device sends a CSI-RS to a terminal device; and the network device receives channel state information fed back by the terminal device, where the channel state information indicates one or more first bases, and the one or more first bases are used to generate, based on a preset base generation method, one or more second bases indicating the channel state information. In this way, a base of the terminal device is aligned with a base of the network device, so that channel reconstruction and precoding is performed more accurately, thereby improving system performance.

In at least one embodiment, the one or more first bases are one or more space-domain and frequency-domain combined statistical covariance base column vectors obtained through quantization.

In at least one embodiment, the preset base generation method is an orthogonalization method preconfigured or predefined by the network device. In this way, the aligned bases of the terminal device and the network device is obtained accurately by using the orthogonalization method preconfigured or predefined by the network device.

According to a fifth aspect, at least one embodiment further provides a channel state information feedback apparatus. The channel state information feedback apparatus has a function of implementing the terminal device in any one of the first aspect or the design examples of the first aspect or any one of the third aspect or the design examples of the third aspect. The function is implemented by hardware, or is implemented by executing corresponding software by hardware. The hardware or software includes one or more modules corresponding to the foregoing function.

In at least one embodiment, a structure of the channel state information feedback apparatus includes a transceiver unit and a processing unit. These perform corresponding functions of the terminal device in any one of the first aspect or the design examples of the first aspect or any one of the third aspect or the design examples of the third aspect. For details, refer to the detailed descriptions in the method examples. Details are not described herein again.

In at least one embodiment, a structure of the channel state information feedback apparatus includes a transceiver and a processor, and optionally, further includes a memory. The transceiver is configured to receive and send information, signals, or data, and is configured to communicate and interact with another device in a communications system. The processor is configured to support the channel state information feedback apparatus in performing corresponding functions of the terminal device in any one of the first aspect or the design examples of the first aspect or any one of the third aspect or the design examples of the third aspect. The memory is coupled to the processor, and stores program instructions and data that are used for the channel state information feedback apparatus.

In at least one embodiment, a structure of the channel state information feedback apparatus includes a memory and a processor. The processor is configured to support the channel state information feedback apparatus in performing corresponding functions of the terminal device in any one of the first aspect or the design examples of the first aspect or any one of the third aspect or the design examples of the third aspect. The memory is coupled to the processor, and stores program instructions and data that are used for the channel state information feedback apparatus.

According to a sixth aspect, at least one embodiment further provides a channel state information feedback apparatus. The channel state information feedback apparatus has a function of implementing the network device in any one of the second aspect or the design examples of the second aspect or any one of the fourth aspect or the design examples of the fourth aspect. The function is implemented by hardware, or is implemented by executing corresponding software by hardware. The hardware or software includes one or more modules corresponding to the foregoing function.

In at least one embodiment, a structure of the channel state information feedback apparatus includes a transceiver unit and a processing unit. These units perform corresponding functions of the network device in any one of the second aspect or the design examples of the second aspect or any one of the fourth aspect or the design examples of the fourth aspect. For details, refer to the detailed descriptions in the method examples. Details are not described herein again.

In at least one embodiment, a structure of the channel state information feedback apparatus includes a transceiver and a processor, and optionally, further includes a memory. The transceiver is configured to receive and send information, signals, or data, and is configured to communicate and interact with another device in a communications system. The processor is configured to support the channel state information feedback apparatus in performing corresponding functions of the network device in any one of the second aspect or the design examples of the second aspect or any one of the fourth aspect or the design examples of the fourth aspect. The memory is coupled to the processor, and stores program instructions and data that are used for the channel state information feedback apparatus.

In at least one embodiment, a structure of the channel state information feedback apparatus includes a memory and a processor. The processor is configured to support the channel state information feedback apparatus in performing corresponding functions of the terminal device in any one of the first aspect or the design examples of the first aspect or any one of the third aspect or the design examples of the third aspect. The memory is coupled to the processor, and stores program instructions and data that are used for the channel state information feedback apparatus.

According to a seventh aspect, at least one embodiment provides a communications system. The communications system includes the terminal device and the network device that are mentioned above.

According to an eighth aspect, at least one embodiment provides a computer-readable storage medium. The computer-readable storage medium stores program instructions. In response to the program instructions being run on a computer, the computer is enabled to perform the method according to any one of the first aspect or the designs of the first aspect, any one of the second aspect or the designs of the second aspect, any one of the third aspect or the designs of the third aspect, or any one of the fourth aspect or the designs of the fourth aspect in at least one embodiment. For example, the computer-readable storage medium is any usable medium accessible to a computer. By way of example and without any limitation, the computer-readable medium includes a non-transitory computer-readable medium, a random access memory (RAM), a read-only memory (ROM), an electrically erasable programmable read-only memory (electrically EPROM, EEPROM), a CD-ROM or another optical disc storage, a magnetic disk storage medium or another magnetic storage device, or any other medium that is used for carrying or storing expected program code in a form of an instruction or a data structure and that is accessed by a computer.

According to a ninth aspect, an embodiment of at least one embodiment provides a computer program product that includes computer program code or instructions. In response to the computer program product running on a computer, the computer is enabled to implement the method according to any one of the first aspect or the designs of the first aspect, any one of the second aspect or the designs of the second aspect, any one of the third aspect or the designs of the third aspect, or any one of the fourth aspect or the designs of the fourth aspect.

According to a tenth aspect, at least one embodiment further provides a chip, including a processor. The processor is coupled to a memory, and is configured to read and execute program instructions stored in the memory, so that the chip implements the method according to any one of the first aspect or the designs of the first aspect, any one of the second aspect or the designs of the second aspect, any one of the third aspect or the designs of the third aspect, or any one of the fourth aspect or the designs of the fourth aspect.

For each of the fifth aspect to the tenth aspect and technical effects that is achieved by each of the fifth aspect to the tenth aspect, refer to the foregoing descriptions of the technical effects that is achieved by any one of the first aspect or the solutions of the first aspect, any one of the second aspect or the solutions of the second aspect, any one of the third aspect or the solutions of the third aspect, or any one of the fourth aspect or the solutions of the fourth aspect. Details are not described herein again.

### BRIEF DESCRIPTION OF DRAWINGS

FIG. 1 is a schematic diagram of an architecture of a communications system according to at least one embodiment;

FIG. 2 is a schematic diagram of communication between a network device and a terminal device according to at least one embodiment;

FIG. 3 is a schematic diagram of a basic procedure of CSI measurement by a network device and a terminal device according to at least one embodiment;

FIG. 4 is a schematic diagram of a CSI feedback delay according to at least one embodiment;

FIG. 5 is a schematic diagram of a CSI measurement and feedback procedure according to at least one embodiment;

FIG. 6 is a flowchart of a channel state information feedback method according to at least one embodiment;

FIG. 7 is a schematic diagram of a codebook according to at least one embodiment;

FIG. 8 is a schematic diagram of another codebook according to at least one embodiment;

FIG. 9 is a flowchart of another channel state information feedback method according to at least one embodiment;

FIG. 10 is a schematic diagram of a structure of a channel state information feedback apparatus according to at least one embodiment; and

FIG. 11 is a diagram of a structure of a channel state information feedback apparatus according to at least one embodiment.

### DESCRIPTION OF EMBODIMENTS

The following further describes at least one embodiment in detail with reference to the accompanying drawings.

Embodiments described herein provide a channel state information feedback method and apparatus, to resolve a problem that system performance is poor because fed-back CSI is inaccurate due to CSI expiration in a scenario of a time-varying channel in a conventional technology. The method and apparatus in at least one embodiment are based on a same technical idea. Because problem resolving principles of the method and apparatus are similar, mutual reference is made between implementations of the apparatus and method, and repeated parts are not described again.

The following explains and describes some terms in at least one embodiment, to facilitate understanding by a person skilled in the art.

### (1) Precoding

In response to a channel state being known, a network device processes a to-be-sent signal by using a precoding matrix that matches a channel resource, so that a precoded to-be-sent signal is adapted to a channel, thereby improving received signal quality (for example, a signal to interference plus noise ratio (SINR)) of a receive end (also referred to as a receiving device). This reduces complexity of inter-channel impact elimination by the receive end. With a precoding technology, a transmit end (also referred to as a sending end or a sending device) and a plurality of receive ends performs transmission on a same time-frequency resource, that is, multi-user multiple input multiple output (MU-MIMO) is implemented. Related descriptions about the precoding technology are merely used as an example for ease of understanding, and are not intended to limit the protection scope of embodiments described herein. In a specific implementation process, alternatively, a transmit end performs precoding in another manner. For example, in response to channel information (for example, but not limited to, a channel matrix) not being learned, precoding is performed by using a preset precoding matrix or through weighting processing. For brevity, specific content thereof is not described herein.

### (2) Precoding Matrix Indicator (PMI)

A precoding matrix indicator indicates a precoding matrix, and a network device obtains the precoding matrix based on the PMI. The precoding matrix is a precoding matrix that is determined by a terminal device based on a channel matrix of each frequency-domain unit. The frequency-domain unit is a unit of a frequency-domain resource, and represents different frequency-domain resource granularities. For example, the frequency-domain unit includes but is not limited to a subband, a resource block (RB), a subcarrier, a resource block group (RBG), or a precoding resource block group (PRG). In addition, a frequency-domain length of one frequency-domain unit is R times a subband or frequency-domain subband, where R is less than or equal to 1. For example, a value of R is 1 or 1/2. The channel matrix is determined by the terminal device through channel estimation or the like or based on channel reciprocity. However, a method for determining the precoding matrix by the terminal device is not limited to the foregoing descriptions. For a specific implementation, refer to a conventional technology. For brevity, examples are not listed herein.

For example, the precoding matrix is obtained by performing singular value decomposition (SVD) on the channel matrix or a covariance matrix of the channel matrix, or is obtained by performing eigenvalue decomposition (EVD) on a covariance matrix of the channel matrix. The foregoing listed manners of determining the precoding matrix are merely examples, and shall not constitute any limitation on at least one embodiment. For a manner of determining the precoding matrix, refer to a conventional technology. For brevity, examples are not listed herein.

### (3) Channel State Information (CSI)

Channel state information is information that is used to describe a channel attribute of a communications link and that is reported by a receive end (for example, a terminal device) to a transmit end (for example, a network device) in a wireless communications system. A CSI report includes but is not limited to a precoding matrix indicator (PMI), a rank indicator (RI), a channel quality indicator (CQI), a channel state information reference signal (CSI-RS) resource indicator (CRI), a layer indicator (LI), and the like. The CSI content listed above is merely examples for description, and shall not constitute any limitation on embodiments described herein. The CSI includes one or more of the foregoing listed items, or includes information that is other than the foregoing listed items and that is used to represent the CSI. This is not limited in embodiments described herein.

### (4) Antenna Port

An antenna port is also referred to as a port, and is understood as a transmit antenna identified by a receive end, or a transmit antenna that is distinguished in space. One antenna port is preconfigured for each virtual antenna. Each virtual antenna is a weighted combination of a plurality of physical antennas. Each antenna port corresponds to one reference signal. Therefore, each antenna port is referred to as a port of one reference signal, for example, a channel state information reference signal (CSI-RS) port or a sounding reference signal (SRS) port. In embodiments described herein, an antenna port is a transceiver unit (TxRU).

### (5) Sounding Duration

In embodiments described herein, a terminal device performs channel sounding within a time segment based on an indication of a network device. The time segment is referred to as sounding duration. A time length of the time segment is indicated by the network device by using signaling. For example, the time length is notified by using higher layer signaling (for example, a radio resource control (RRC) message). Alternatively, the sounding duration is predefined, for example, defined in a protocol. This is not limited in at least one embodiment.

The network device notifies, by using signaling, the terminal device to start to perform channel sounding. For example, the network device notifies the terminal device of a start time and/or duration of the time segment by using signaling, or the network device triggers, by using signaling, the terminal device to start to perform channel sounding. The terminal device receives, for a plurality of times within the sounding duration, reference signals used for channel sounding, and performs channel sounding based on the reference signals received for the plurality of times, to feed back a time-varying characteristic of a channel to the network device. The sounding duration is short, for example, is defined in slots (slot) or milliseconds (ms). For example, the sounding duration is 20 slots, 5 ms, 10 ms, or 20 ms. Alternatively, the sounding duration is long, for example, is defined in seconds. For example, the sounding duration is 10 seconds.

The network device notifies, by using signaling, the terminal device to start to perform channel sounding does not mean that the terminal device keeps performing channel sounding since the start time or a trigger time indicated by the network device. The network device uses the signaling merely to notify the terminal device that the terminal device performs channel sounding. The terminal device performs channel sounding based on the received reference signals within one time window after the start time or the trigger time. A magnitude of the time window is the sounding duration.

The feeding back herein is feeding back the time-varying characteristic of the channel by the terminal device, but this does not mean that the terminal device gives no other feedback. For example, the terminal device gives a feedback within the time segment based on a feedback manner of a type II codebook. For brevity, examples are not listed herein. Another feedback given by the terminal device within the time segment is a process independent of the feedback of the time-varying characteristic of the channel in at least one embodiment.

### (6) Time-Domain Base

A time-domain base is also referred to as a time-domain vector, and is used to represent a change of a channel in time domain. One time-domain vector represents one rule by which a channel changes with time. A wireless channel is a time-varying channel, and suffers attenuation losses from different paths. For example, a time-frequency doubly selective fading channel affected by both frequency selective fading caused by multipath delay spread and time selective fading caused by a Doppler frequency shift is a typical time-varying channel.

A Doppler frequency shift (Doppler shift) is a frequency shift that is between a transmit frequency and a receive frequency and that is caused by relative movement between a terminal device and a network device, and a difference between the receive frequency and the transmit frequency is referred to as the Doppler frequency shift. Usually, a Doppler frequency shift f d is defined as f_{d}=v×f_{c}×cos θ/c, where v is a moving speed of a terminal device, f_{c} is a carrier frequency, θ is an incident angle of a multipath signal, and c is a speed of light. During specific implementation, incident angles of different transmission paths is considered for θ. Because the plurality of paths have different θthe different transmission paths correspond to different Doppler frequency shifts, causing Doppler spread (Doppler spread). Generally, a magnitude of a Doppler frequency shift represents impact of a moving speed on a time-domain change speed of a channel.

In embodiments described herein, one time-domain vector corresponds to one Doppler frequency shift. Therefore, different time-domain vectors is used to represent rules of time-domain channel changes caused by Doppler frequency shifts corresponding to different transmission paths. Usually, for ease of describing a time-domain change of a channel, the time-domain channel is projected to a Doppler domain, and the change is represented through weighting of exponential functions of several slowly varying Doppler frequency shifts.

The time-domain vector is defined merely for ease of distinguishing from the following space-domain vector and frequency-domain vector, and shall not constitute any limitation on at least one embodiment. At least one embodiment does not exclude a possibility of defining another name for the time-domain vector in a future protocol to represent a meaning that is the same as or similar to that of the time-domain vector. For example, the time-domain vector is also referred to as a Doppler vector.

Optionally, the time-domain vector is one or more of a discrete Fourier transform (DFT) vector, an oversampled DFT vector, a wavelet transform (WT) vector, or an oversampled WT vector. This is not limited in at least one embodiment.

### (7) Space-Domain Base

A space-domain base is also referred to as a space-domain vector, or referred to as a beam vector, an angle vector, or the like. All elements in a space-domain vector represents weights of all antenna ports (antenna port). Based on weights of all antenna ports represented by all elements in a space-domain vector, signals of the antenna ports are linearly superposed, so that an area in which signal strength is high is formed in a direction in space. A reference signal is precoded based on a space-domain vector, so that the transmitted reference signal has specific spatial directivity. Therefore, a process of precoding a reference signal based on a space-domain vector is also considered as a process of space-domain precoding.

Optionally, a space-domain vector is taken from a DFT matrix. Each column vector in the DFT matrix is referred to as a DFT vector. In other words, a space-domain vector is a DFT vector. A space-domain vector is alternatively, for example, a two-dimensional (2D) DFT vector or an oversampled 2D-DFT vector defined in a type II codebook in the NR protocol TS 38.214 release 15 (R15). For brevity, details are not described herein.

### (8) Frequency-Domain Base

A frequency-domain base is referred to as a frequency-domain vector, a delay vector, or the like. A frequency-domain base is a vector that is used to represent a frequency-domain change rule of a channel. Each frequency-domain vector represents one change rule. In response to being transmitted through a wireless channel, a signal arrives at a receive antenna through a plurality of paths from a transmit antenna. A multipath delay causes frequency selective fading, which is a frequency-domain channel change. Therefore, different frequency-domain vectors is used to represent rules of frequency-domain channel changes caused by delays on different transmission paths. However, a phase change of a channel in each frequency-domain unit is related to a delay, and from Fourier transform that a time delay of a signal in time domain is equivalent to a phase gradient in frequency domain. Therefore, a frequency-domain vector is also referred to as a delay vector. In other words, a frequency-domain vector is also used to represent a delay characteristic of a channel

That a reference signal is precoded based on a frequency-domain vector essentially means that phase rotation is performed on each frequency-domain unit in frequency domain based on an element in the frequency-domain vector, to pre-compensate, through reference signal precoding, for a frequency selective characteristic caused by a multipath delay. Therefore, a process of precoding a reference signal based on a frequency-domain vector is considered as a process of frequency-domain precoding.

In embodiments described herein, a frequency-domain vector is used to construct, with the foregoing space-domain vector, a plurality of combinations of space-domain vectors and frequency-domain vectors, also referred to as space-frequency vector pairs for short, to construct a precoding vector.

### (9) Transmit-End Space-Domain and Frequency-Domain Joint Compression

Transmit-end space-domain and frequency-domain joint compression means to use a transmit-end space-domain and frequency-domain vector (for example, a transmit-end space-domain and frequency-domain column vector or a transmit-end space-domain and frequency-domain row vector) to represent a channel represented by a transmit-end space-domain-frequency-domain matrix (a transmit-end space-domain vector matrix and a frequency-domain vector matrix). In other words, a transmit-end space-domain and frequency-domain vector indicates a channel in a combination of transmit-end space domain and frequency domain. A downlink channel is used as an example. A terminal device has a single antenna, and the channel is a single-polarized channel The channel H is represented by a formula (1), that is, H meets the formula (1):

H=SCF^{H} (1)

In the formula (1), H∈C^{M×N}, S∈C^{M×L}, F∈C^{N×L}, and C∈C^{L×L}, that is, C is a diagonal matrix of L×L, where M is a quantity of antenna ports of a network device, L is a quantity of paths, N is a quantity of frequency units, and C represents a complex number set in at least one embodiment.

H in the formula (1) is expanded by row, that is, a channel represented by a transmit-end space-domain—frequency-domain matrix is represented by a transmit-end space-domain and frequency-domain row vector, to obtain the following:

$$h = [ \begin{matrix}{H ( 1 , : )}^{T} \\ {H ( 2 , : )}^{T} \\ … \\ {H ( M , L )}^{T}\end{matrix} ] = {[ H ( 1 , : ) H ( 2 , : ) … H ( M , : ) ]}^{T} ,$$

where (m:) represents the m^{th} row of the matrix, and m=1, . . . , M.

H in the formula (1) is expanded by column, that is, a channel represented by a transmit-end space-domain—frequency-domain matrix is represented by a transmit-end space-domain and frequency-domain column vector, to obtain the following:

$$h = [ \begin{matrix}H ( : , 1 ) \\ H ( : , 2 ) \\ … \\ H ( : , L )\end{matrix} ] ,$$

where (:, l) represents the l^{th} column of the matrix, and l=1, . . . , L.

In response to H in the formula (1) being represented by a column vector, a column vector equivalent to the formula (1) meets a formula (2):

h=(F*□S)c∈C^{MN×l} (2)

Herein, h is also considered as a representation of a channel in a combined transmit-end space-frequency domain (a combined domain of a transmit-end space domain and frequency domain). For ease of description, in at least one embodiment, h is referred to as a transmit-end space-domain and frequency-domain channel. In the formula (2), c=diag(C) , where diag(C) represents a column vector that includes a diagonal element of the matrix C; and F*□S∈C^{MN×L}, where □ represents a Khatri-Rao product. For example, in A□B=[a₁⊗b₁ . . . aₙ⊗bₙ ], aᵢ is the i^{th} column of A, ⊗ is a Kronecker product, bᵢ is the i^{th} column of B, and i is an integer greater than 0. F* is a conjugate matrix of F, and the l(l=1, . . . , L) th column of the matrix F*□S meets a formula (3):

(F*□S)(:, l)=F(:, l)*⊗S(:, l)∈C^{MN×l} (3)

Herein, (:, l) represents the l^{th} column of the matrix.

For the channel h represented by a column vector, statistical covariance matrix SVD thereof meets a formula (4):

Rₕ=E{hh^{H}}=UΛU^{H} (4)

Herein, [symbol] represents obtaining an expectation for a random number/matrix, U is an eigenvector of a channel Rₕ, an eigenvalue corresponding to each column of U is an element on a diagonal of a diagonal matrix Λ, and elements on the diagonal of Λ are arranged in descending order. In this case, an instantaneous channel meets a formula (5):

h=Uĥ (5)

Herein, ĥ is a projection of h on U, ĥₚ=Uₚ^{H}h is a projection of h on Uₚ, and Uₚ=U(:, l:P), indicating that Uₚ is a matrix constituted by selecting one to P columns from U.

Alternatively, h≈Uₚĥₚ, that is, Uₚĥₚ represents an approximation of h.

The channel has a characteristic of being sparse in an angle-delay domain, that is, only some of elements in ĥ are non-zero or have large values. In addition, an angle-delay change speed is low, that is, U remains basically unchanged within a period of time, and values of ĥ at different moments, for example, ĥ₁, ĥ₂ . . . ĥₜ, change with time. Joint compression in the transmit-end space domain and frequency domain enhances sparsity of a projection coefficient of the channel H on a transmit-end space-domain and frequency-domain combined base, so that precision of CSI reconstruction by the network device is increased, thereby improving system performance.

### (10) Transmit-End Space-Domain and Frequency-Domain Combined Base

A transmit-end space-domain and frequency-domain combined base is also referred to as a transmit-end space-domain and frequency-domain combined vector, and is a vector that is used to represent a rule by which a channel changes in a combination of a transmit-end space domain and frequency domain. In embodiments described herein, in response to two polarization directions of a channel corresponding to a same transmit-end space-domain and frequency-domain combined base, a dimension of a transmit-end space-domain and frequency-domain combined vector matrix is ((M₁×M₂)×N_{sb})×L, where M₁ is a quantity of antenna ports in a horizontal direction of transmission by a network device, M₂ is a quantity of antenna ports in a vertical direction of transmission by the network device, N_{sb} is a quantity of frequency units, and L is a quantity of paths or a selected quantity of transmit-end space-domain and frequency-domain combined bases. In response to two polarization directions of a channel corresponding to different transmit-end space-domain and frequency-domain combined bases, a dimension of a transmit-end space-domain and frequency-domain combined vector matrix is (2×(M₁×M₂l )×N_{sb})×L. For example, a transmit-end space-domain and frequency-domain combined vector matrix is obtained by performing SVD on a covariance matrix of a channel h represented by a column vector in transmit-end space-domain and frequency-domain joint compression.

### (11) Receive-End Space-Domain and Time-Domain Combined Base

A receive-end space-domain and time-domain combined base is also referred to as a receive-end space-domain and time-domain combined vector, and is a vector that is used to represent a rule by which a channel changes in a combination of a receive-end space domain and time domain. In embodiments described herein, a dimension of a receive-end space-domain and time-domain combined vector matrix is (M₃×N_{d})×N₁, where M₃ is a quantity of antenna ports of a terminal device, N_{d} represents sounding duration, and N₁ is a selected quantity of receive-end space-domain and time-domain combined bases. For example, a receive-end space-domain and time-domain combined vector matrix is obtained by performing SVD on a covariance matrix of a channel represented by a column vector in receive-end space-domain and time-domain joint compression.

### (12) Complex Coefficient Matrix

A complex coefficient matrix is also referred to as a projection coefficient matrix, and is used to represent a projection coefficient of a channel on a transmit-end space-domain and frequency-domain combined base matrix and a receive-end space-domain and time-domain combined base matrix, or is used to represent a projection coefficient of a channel on a transmit-end space-domain and frequency-domain combined base matrix and a time-domain base matrix, where a complex coefficient includes an amplitude and a phase.

Matrix and vector transformation is used at a plurality of places in embodiments described herein. For ease of description, a unified description is provided herein. A superscript T represents transpose, for example, A^{T} represents transpose of a matrix (or vector) A. A superscript H represents conjugate transpose, for example, A^{H} represents conjugate transpose of a matrix (or vector) A. A superscript * represents conjugate, for example, A* represents conjugate of a matrix (or vector) A. For brevity, descriptions of a same or similar case are omitted below.

In the descriptions of at least one embodiment, words such as “first” and “second” are merely intended for differentiated description, and shall not be understood as an indication or implication of relative importance or an indication or implication of a sequence.

In the descriptions of at least one embodiment, “at least one” means one or more, and “a plurality of” means two or more.

The expression “and/or” describes an association relationship between associated objects and represents that three relationships exist. For example, A and/or B represents the following three cases: Only A exists, both A and B exist, and only B exists. The character “/” generally indicates an “or” relationship between associated objects.

To describe the technical solutions in embodiments described herein more clearly, the following describes in detail, with reference to the accompanying drawings, the channel state information feedback method and apparatus provided in embodiments described herein.

The channel state information feedback method provided in embodiments described herein is applied to various communications systems, provided that the communications system includes a device that sends transmission direction indication information and another device that receives the indication information and determine, based on the indication information, a transmission direction used within a specific time. For example, the communications system is an Internet of things (IoT), a narrowband Internet of things (NB-IoT), or long term evolution (LTE), is a 5th generation (5G) communications system, is an LTE and 5G hybrid architecture, or is a 5G NR system or a new communications system emerging in future development of communications. The 5G communications system in at least one embodiment includes at least one of a non-standalone (NSA) 5G communications system and a standalone (SA) 5G communications system. Alternatively, the communications system is a public land mobile network (PLMN), a device-to-device (D2D) network, a machine-to-machine (M₂M) network, or another network.

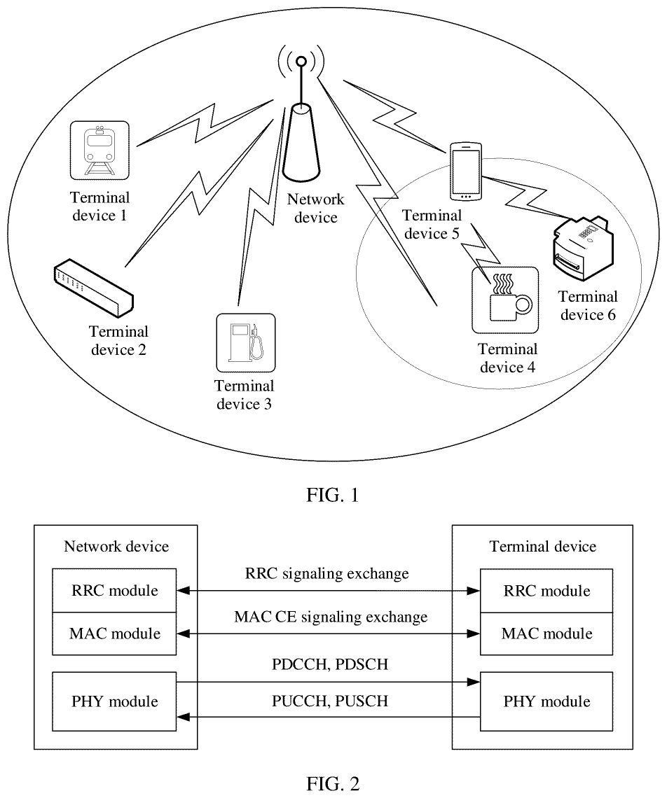

FIG. 1 is a schematic diagram of an architecture of a communications system to which the channel state information feedback method provided in at least one embodiment is applicable. The communications system includes a network device and at least one terminal device, for example, a terminal device 1 to a terminal device 6 that are shown in FIG. 1. In the communications system, the terminal device 1 to the terminal device 6 sends uplink data or the like to the network device, and the network device receives the uplink data or the like sent by the terminal device 1 to the terminal device 6. In addition, a terminal device 1 to the terminal device 6 also constitutes a communications subsystem. The network device sends downlink information or the like to the terminal device 1, a terminal device 2, a terminal device 5, and the like. The terminal device 5 also sends downlink information or the like to the terminal device 1 and the terminal device 6 based on a D2D technology. FIG. 1 is merely a schematic diagram, and at least one embodiment does not impose any specific limitation on a type of the communications system or a quantity, types, or the like of devices included in the communications system.

The network device is a device having a wireless transceiver function, or a chip that is disposed in such a network device. The network device includes but is not limited to a gNodeB (gNB), a radio network controller (RNC), a NodeB (NB), a base station controller (BSC), a base transceiver station (BTS), a home base station (for example, a home evolved NodeB or a home NodeB, HNB), a baseband unit (BBU), an access point (AP) in a wireless fidelity (Wi-Fi) system, a wireless relay node, a wireless backhaul node, a transmission point (TRP, or TP), or the like, or is a network node that constitutes a gNB or a transmission point, such as a baseband unit (BBU) or a distributed unit (DU).

In some deployments, the gNB includes a central unit (CU) and a DU. The gNB further includes a radio frequency unit (RU). The CU implements some of functions of the gNB, and the DU implements some of the functions of the gNB. For example, the CU implements functions of radio resource control (RRC) and packet data convergence protocol (PDCP) layers, and the DU implements functions of radio link control (RLC), media access control (MAC), and physical (PHY) layers. RRC layer information is finally changed to PHY layer information, or is converted from PHY layer information. Therefore, in such an architecture, higher layer signaling, such as RRC layer signaling or PHCP layer signaling, is also considered as being sent by the DU or sent by the DU and the RU. The network device is understood to be a CU node, a DU node, or a device that includes a CU node and a DU node. In addition, the CU is classified as a network device in an access network RAN, or the CU is classified as a network device in a core network CN. This is not limited.

The terminal device is also referred to as user equipment (UE), an access terminal, a subscriber unit, a subscriber station, a mobile station, a remote station, a remote terminal, a mobile device, a user terminal, a terminal, a wireless communications device, a user agent, or a user apparatus. The terminal device in embodiments described herein is a mobile phone, a tablet computer (Pad), a computer with a wireless transceiver function, a virtual reality (VR) terminal device, an augmented reality (augmented reality, AR) terminal device, a wireless terminal in industrial control, a wireless terminal in self driving, a wireless terminal in telemedicine (telemedicine), a wireless terminal in a smart grid, a wireless terminal in transportation safety, a wireless terminal in a smart city, a smart wearable device (smart glasses, a smartwatch, a smart headset, or the like), a wireless terminal in a smart home, or the like, or is a chip, a chip module (or chip system), or the like that is disposed in the foregoing device. An application scenario is not limited in embodiments described herein. In at least one embodiment, a terminal device having a wireless transceiver function and a chip that is disposed in such a terminal device are collectively referred to as a terminal device.

For example, communication between the network device and the terminal device is shown in FIG. 2. Specifically, the network device and the terminal device exchanges RRC signaling by using an RRC module. The network device and the terminal device exchanges media access control control element (MAC CE) signaling by using a MAC module. The network device and the terminal device exchanges uplink/downlink control signaling, for example, a physical uplink control channel (PUCCH)/physical downlink control channel (PDCCH), and exchange uplink/downlink data signaling, for example, a physical uplink shared channel (PUSCH)/physical downlink shared channel (PDSCH), by using a PHY module.

The network architecture and service scenario described in embodiments described herein are intended to describe the technical solutions in embodiments described herein more clearly, and constitute no limitation on the technical solutions provided in embodiments described herein. A person of ordinary skill in the art knows that, with evolution of the network architecture and emergence of new service scenarios, the technical solutions provided in embodiments described herein are also applicable to similar technical problems.

Currently, a 5G communications system has higher goals in aspects such as a system capacity and spectral efficiency. In a 5G communications system, a massive MIMO technology plays a critical role in spectral efficiency of the system. In response to a MIMO technology being used, a network device performs modulation and coding and signal precoding in response to the network device sending data to a terminal device. How the network device sends the data to the terminal device depends on CSI fed back by the terminal device to the network device. Therefore, accuracy of the CSI plays a very important role in system performance

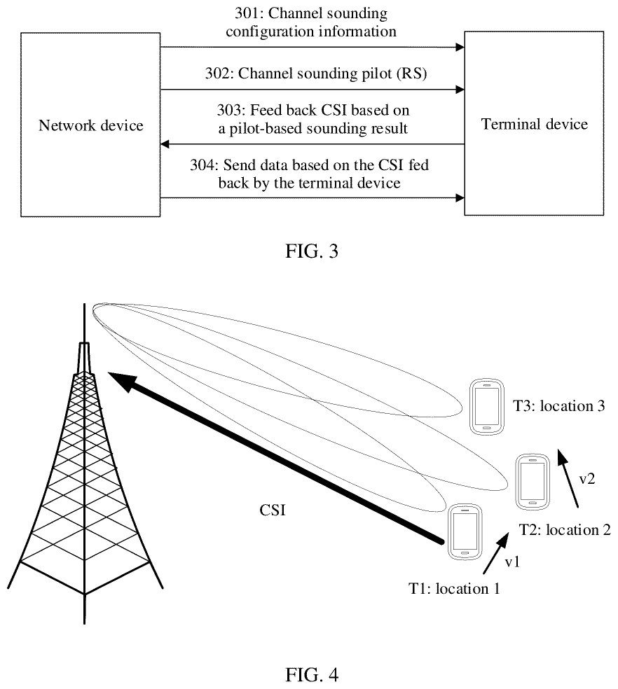

A basic procedure in which a network device and a terminal device perform CSI measurement is shown in FIG. 3, and includes the following operations:

Operation 301: The network device sends channel sounding configuration information to the terminal device, where the channel sounding configuration information is used for channel sounding configuration, for example, configuration of a reference signal and a sounding time.

Operation 302: The network device sends a channel sounding pilot (which is also referred to as a reference signal (RS)) to the terminal device, where the pilot is used for channel sounding.

Operation 303: The terminal device performs channel sounding based on the pilot sent by the network device, performs calculation such as channel estimation to obtain CSI, and feeds back the CSI to the network device (for example, by using a codebook). For example, the fed-back CSI includes a specific parameter such as a rank indicator (RI), a channel quality indicator (CQI), or a precoding matrix indicator (PMI).

Operation 304: The network device sends data based on the CSI fed back by the terminal device. In operation 304, the network device determines, based on the CSI fed back by the terminal device in operation 303, a related configuration for sending the data. For example, the network device determines, based on the RI, a quantity of streams of data transmission to the terminal device; the network device determines, based on the CQI fed back by the terminal device, a modulation order and a channel-coding code rate of data transmission to the terminal device; and the network device determines, based on the PMI fed back by the terminal device, precoding of data transmission to the terminal device.

In an actual system, there is usually a delay in CSI feedback, that is, a specific time is from CSI measurement is used by a terminal device to obtaining, by a network device, CSI fed back by the terminal device. Consequently, the CSI obtained by the network device has an aging problem. To be specific, the CSI that is fed back by the terminal device and that is obtained by the network device is not CSI of a current actual channel, but CSI in a past period of time. As a result, precoding that is used for data sending and that is obtained through calculation by the network device based on the CSI fed back by the terminal device is different from precoding calculated based on the actual channel This causes a system performance loss. In a scenario of a time-varying channel, a delay of CSI feedback causes an obvious performance loss, where a user mobile scenario is one of common scenarios. For example, as shown in FIG. 4, a terminal device is at a location 1 at a moment T1; the UE moves based on a speed and direction of \vec{v1}, and arrives at a location 2 at a moment T2; and then the terminal device moves based on a speed and direction of \vec{v2}, and arrives at a location 3 at a moment T3. The terminal device corresponds to different channels at the location 1, the location 2, and the location 3. Therefore, CSI fed back by the terminal device at the moment T1 is inconsistent with channels corresponding to the location 2 and the location 3. As a result of a CSI expiration problem, precoding of a user cannot match an actual channel condition, and consequently, more inter-user interference is introduced, greatly reducing system performance.

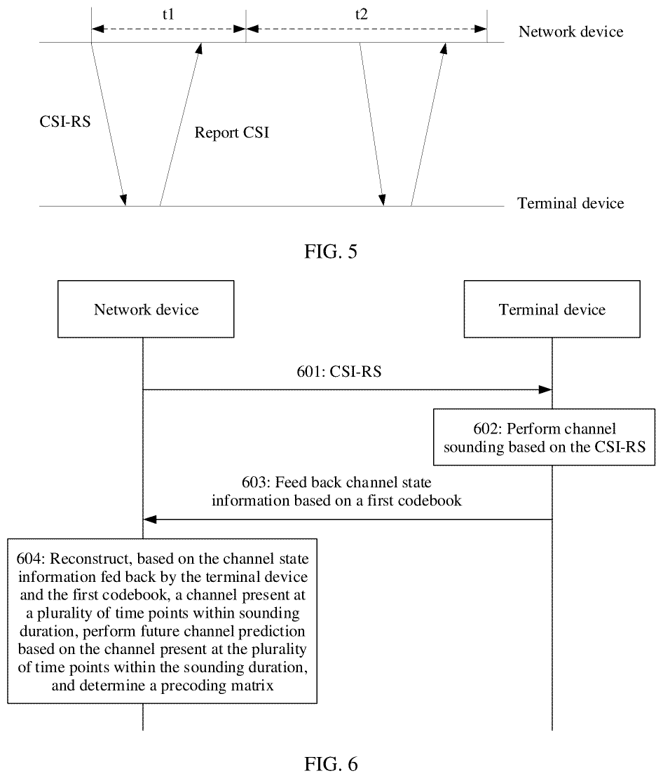

Currently, in a CSI measurement procedure, a network device calculates a precoding matrix based on CSI reported by a terminal device, and the precoding matrix remains unchanged until a next CSI report. In other words, the network device calculates a precoding matrix by using latest reported CSI, and keeps the precoding matrix unchanged until a next CSI update, for example, as shown in FIG. 5.

From a CSI measurement and feedback procedure in FIG. 5, in each CSI measurement and report period, a network device assumes that a channel condition remains unchanged within a CSI report period, and uses latest reported CSI as a basis for subsequent data transmission and precoding design. However, existence of a CSI validation delay t1 and a channel time variation t2 causes a CSI expiration problem. The CSI validation delay t1 is duration from in response to a network device sending a downlink CSI-RS to in response to the network device receiving an uplink CSI feedback of a terminal device and then to in response to the network device obtaining a precoding matrix through calculation based on CSI fed back by the terminal device. Existence of t1 causes a delay between reported CSI and CSI of an actual channel. In response to a channel being time-varying, t1 causes CSI expiration, which results in performance degradation. The channel time variation t2 is duration in which a network device continuously uses latest reported CSI to calculate a precoding matrix during a CSI feedback period. In other words, the precoding matrix is fixed within the duration of t2, that is, the network device assumes that a channel remains unchanged during the CSI feedback period. In response to a channel being time-varying, for example, in a mobile scenario, the channel also changes within the duration of t2. As a result, a precoding matrix calculated based on latest reported CSI does not match CSI of an actual channel This causes performance degradation.

To sum up, a problem that CSI expiration in a channel time-varying scenario causes system performance degradation because precoding that is used for data sending and that is obtained through calculation by a network device based on CSI fed back by a terminal device does not match precoding corresponding to a current actual channel is an urgent problem to be resolved currently. Based on this, embodiments described herein provide a channel state information feedback method to resolve the foregoing problem. Specifically, in at least one embodiment, a terminal device feeds back channel state information based on a first codebook that includes Doppler information (that is, time-domain information), where the channel state information describes a time-varying characteristic of a channel. Changing of the Doppler information is slow within short sounding duration. Therefore, a network device reconstructs, based on the first codebook, channel information present within sounding duration, predict a future channel change trend based on a time-varying trend of a reconstructed channel, and calculate a downlink precoding matrix based on a predicted channel to better match a current channel, thereby improving system performance In addition, in at least one embodiment, transmit-end space-domain and frequency-domain combined and receive-end space-domain and time-domain combined bases are constructed, so that channel projection sparsity is increased, thereby reducing feedback overheads. The channel state information is fed back in four dimensions, namely, a transmit end, a frequency domain, a receive end, and a time domain, or in three dimensions, namely, a transmit end, a frequency domain, and a time domain, so that a channel characteristic is represented more precisely. Therefore, the network device performs channel prediction more accurately based on the channel state information fed back by the terminal device.

In embodiments described herein, channel state information is fed back by a terminal device, or a processor, a chip or chip system, a functional module, or the like in a terminal device; and a CSI-RS is delivered by a network device, or a processor, a chip or chip system, a functional module, or the like in a network device. In the following embodiments, only a terminal device and a network device are used as examples to describe in detail the channel state information feedback method provided in at least one embodiment, but at least one embodiment is not limited thereto.

Based on the foregoing descriptions, a channel state information feedback method provided in at least one embodiment is applicable to the communications system shown in FIG. 1. Refer to FIG. 6. A specific procedure of the method includes the following operations:

Operation 601: A network device sends a CSI-RS to a terminal device, and correspondingly, the terminal device receives the CSI-RS from the network device.

Operation 602: The terminal device performs channel sounding based on the CSI-RS.

Operation 603: The terminal device feeds back channel state information to the network device based on a first codebook.

The first codebook is known by the terminal device and the network device in advance.

Specifically, the network device sends CSI-RSs to the terminal device for a plurality of times within sounding duration. The terminal device performs a plurality of times of channel sounding based on the CSI-RS s sent by the network device for the plurality of times, to obtain channel information corresponding to a plurality of time points within the sounding duration. Then, the terminal device feeds back the channel state information to the network device based on the first codebook and the channel information corresponding to the plurality of time points within the sounding duration. The channel state information represents the channel information of a channel at the plurality of time points within the sounding duration.

In the operation, the first codebook includes Doppler information, and the channel state information fed back based on the first codebook represents the channel information of the channel at the plurality of time points within the sounding duration, and reflects the channel at the plurality of time points. In other words, that the channel state information of the channel at the plurality of time points is fed back based on the first codebook indicates that the first codebook includes the Doppler information (time-domain information).

The first codebook has but is not limited to the following two cases:

Case a1: The first codebook is determined based on one or more transmit-end space-domain and frequency-domain column vectors and one or more receive-end space-domain and time-domain column vectors that represent the channel. The one or more transmit-end space-domain and frequency-domain column vectors indicate channel information in a combination of transmit-end space domain and frequency domain, and the one or more receive-end space-domain and time-domain column vectors indicate channel information in a combination of receive-end space domain and time domain. The one or more receive-end space-domain and time-domain column vectors reflect that the first codebook includes the Doppler information (that is, the time-domain information).

Case a2: The first codebook is determined based on one or more transmit-end space-domain and frequency-domain column vectors and one or more time-domain column vectors that represent the channel. The one or more transmit-end space-domain and frequency-domain column vectors indicate channel information in a combination of transmit-end space domain and frequency domain. The one or more time-domain column vectors reflect that the first codebook includes the Doppler information (that is, the time-domain information).

For example, in response to the terminal device feeding back the channel state information based on the first codebook in the case a1, the channel information of the channel at the plurality of time points within the sounding duration is represented based on the channel information in the combination of transmit-end space domain and frequency domain indicated by the one or more transmit-end space-domain and frequency-domain column vectors in the first codebook and the channel information in the combination of receive-end space domain and time domain indicated by the one or more receive-end space-domain and time-domain column vectors in the first codebook.

For example, in response to the terminal device feeding back the channel state information based on the first codebook in the case a2, the channel information of the channel at the plurality of time points within the sounding duration is represented based on the channel information in the combination of transmit-end space domain and frequency domain indicated by the one or more transmit-end space-domain and frequency-domain column vectors in the first codebook and time-domain channel information indicated by the one or more time-domain column vectors in the first codebook.

In an optional implementation, the first codebook W in the case al meets the following formula 1, that is, a structure of the first codebook is represented by the formula 1:

W=W₁W₂W₃^{H} Formula 1

Herein, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, W₂ is a complex coefficient matrix corresponding to the transmit-end space-domain and frequency-domain combined base matrix and the receive-end space-domain and time-domain combined base matrix, and WV is a transposed matrix of W₃.

For example, the transmit-end space-domain and frequency-domain combined base matrix W₁ meets the following formula 2:

W₁=W₁₁W₁₂ Formula 2

Herein, W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

In at least one embodiment, a basic base matrix is a matrix known by both the terminal device and the network device.

Optionally, the transmit-end space-domain and frequency-domain combined basic base matrix W₁₁ is a discrete Fourier transform (DFT) base matrix. Optionally, two polarization directions of the channel corresponds to a same transmit-end space-domain and frequency-domain combined base. In this case, a dimension of the transmit-end space-domain and frequency-domain combined basic base matrix W₁₁ is ((M₁×M₂)×N_{sb})×S₁, where M₁ is a quantity of antenna ports in a horizontal direction of transmission by the network device, M₂ is a quantity of antenna ports in a vertical direction of transmission by the network device, N_{sb} is a quantity of frequency units, and S₁ is a selected quantity of transmit-end space-domain and frequency-domain combined basic bases. Optionally, two polarization directions of the channel corresponds to different transmit-end space-domain and frequency-domain combined bases. In this case, a dimension of the transmit-end space-domain and frequency-domain combined basic base matrix is (2×(M₁×M₂)×N_{sb})×S₁.

Optionally, the transmit-end space-domain and frequency-domain combined basic base correction matrix W₁₂ is also referred to as a coefficient feedback matrix or projection coefficient matrix of a transmit-end space-domain and frequency-domain combined base to a DFT base, and is used to make W₁₁ approximate to W₁. A dimension of W₁₂ is S₁×L, where L is a quantity of paths or a selected quantity of transmit-end space-domain and frequency-domain combined bases. L is a value preconfigured or predefined by the network device.

For example, the network device preconfigures L by using one or more of RRC signaling, MAC CE signaling, and downlink control information (DCI) signaling.

Specifically, one frequency-domain basic base in the transmit-end space-domain and frequency-domain combined basic base matrix W₁₁ corresponds to a plurality of transmit-end space-domain basic bases, or one transmit-end space-domain basic base in the transmit-end space-domain and frequency-domain combined base matrix W₁ corresponds to a plurality of frequency-domain basic bases.

In an example implementation, W₁₁ meets the following formula 3:

W₁₁=W_{f}*⊗Wₜₓ Formula 3

Herein, W_{f}* is a conjugate matrix of W_{f}, W_{f} indicates a frequency-domain basic base, Wₜₓ indicates a transmit-end space-domain basic base, and ⊗ is a Kronecker product.

Optionally, the frequency-domain basic base W_{f} and the transmit-end space-domain basic base Wₜₓ is DFT matrices.

Optionally, a feedback period of the channel state information is classified into a long period and a short period. The long period is, for example, 100 ms. The short period is, for example, 20 ms. During channel state information feedback, different feedback periods is used to feed back different information.

For example, a feedback period T1 of the transmit-end space-domain and frequency-domain combined basic base correction matrix W₁₂ is the long period, and such information is reported to the network device based on the long period, to reduce overheads. T1 is a value preconfigured or predefined by the network device. A feedback period of first information that is in the channel state information and that is other than information fed back based on W₁₂ is the short period, and T1 is greater than the period of feeding back the first information. In other words, a feedback period of channel state information that is fed back based on the first codebook and that is other than fed-back W₁₂ is the short period. For example, feedback periods of W₂ and W₃₂ (the first information) is the short period.

T1 is the long period, and is, for example, 100 ms. The period of the other channel state information (the first information) fed back based on the first codebook is the short period, and is, for example, 20 ms.

For example, the network device preconfigures T1 by using one or more of RRC signaling, MAC CE signaling, and DCI signaling.

In at least one embodiment, the receive-end space-domain and time-domain combined base matrix W₃ meets the following formula 4:

W₃=W₃₁W₃₂ Formula 4

Herein, W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and the sounding duration.

Optionally, the receive-end space-domain and time-domain combined basic base matrix W₃₁ is a DFT matrix. A dimension of W₃₁ is (M₃×N_{d})×S₂, where M₃ is the quantity of antennas of the terminal device, N_{d} is the sounding duration, and S₂ is a selected quantity of receive-end space-domain and time-domain combined basic bases.

Optionally, the receive-end space-domain and time-domain combined basic base correction matrix W₃₂ is also referred to as a coefficient feedback matrix or projection coefficient matrix of a receive-end space-domain and time-domain combined base to a DFT base, and is used to make W₃₁ approximate to W₃. A dimension of W₃₂ is S₂×N₁, where N₁ represents a selected quantity of receive-end space-domain and time-domain combined bases.

N₁ is a value preconfigured or predefined by the network device.

For example, the network device preconfigures N₁ by using one or more of RRC signaling, MAC CE signaling, and DCI signaling.

Specifically, one time-domain basic base in the receive-end space-domain and time-domain combined basic base matrix W₃₁ corresponds to a plurality of receive-end space-domain basic bases, or one receive-end space-domain basic base in the receive-end space-domain and time-domain combined base matrix W₃ corresponds to a plurality of time-domain basic bases.

In an example implementation, W₃₁ meets the following formula 5:

W₃₁=Wₜ*⊗Wᵣₓ Formula 5

Herein, Wₜ* is a conjugate matrix of Wₜ, Wₜ indicates a time-domain basic base, Wᵣₓ indicates a receive-end space-domain basic base, and ⊗ is a Kronecker product.

Optionally, the time-domain basic base Wₜ and the receive-end space-domain basic base Wᵣₓ is DFT matrices.

In a specific manner, a dimension of W₂ is L*N₁. For explanations of L and N₁, refer to the foregoing related descriptions of L and N₁. Details are not described herein again.

In another optional implementation, the first codebook W in the case a2 meets the following formula 6, that is, a structure of the first codebook is represented by the formula 6:

W=W₁W₄ W₅^{H} Formula 6

Herein, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, W₄ is a complex coefficient matrix corresponding to the transmit-end space-domain and frequency-domain combined base matrix and the time-domain base matrix, and W₅^{H} is a transposed matrix of W₅.

Herein, W₁ is the same as W₁ used in the formula 1. For specific related explanations of W₁, refer to the foregoing related descriptions. Details are not described herein again.

Optionally, the time-domain base matrix W₅ is a DFT matrix, and a dimension of W₅ is N_{d}×N_{d}.

For example, a dimension of W₄ is L×N_{d}, where L is a quantity of paths or a selected quantity of transmit-end space-domain and frequency-domain combined bases, and N_{d} represents the sounding duration.

In an optional implementation, before channel sounding, the network device first notifies the terminal device of a CSI obtaining solution. For example, the terminal device receives second information from the network device, where the second information indicates a codebook type used by the terminal device for channel sounding. For example, an implementation is that the second information is a higher layer parameter codebook type (codebookType) of RRC. Specifically, the codebook type corresponding to this embodiment is set to a non-precoding type ‘typeIIr18-mobility-NonePrecoding’ in an R18 mobile scenario.

For example, in response to the terminal device feeding back the CSI based on the first codebook described in the case al, the terminal device feeds back one or more bases based on W₁ and W₃, and feed back, based on W₂, one or more coefficients corresponding to the transmit-end space-domain and frequency-domain combined base matrix and the receive-end space-domain and time-domain combined base matrix. In other words, the CSI fed back by the terminal device based on the first codebook described in the case al includes the one or more bases fed back based on W₁ and W₃, and the one or more coefficients that are fed back based on W₂ and that correspond to the transmit-end space-domain and frequency-domain combined base matrix and the receive-end space-domain and time-domain combined base matrix. The foregoing information included in the CSI is merely an example, and the CSI further includes other information. This is not limited in at least one embodiment.

For example, in response to the terminal device feeding back the CSI based on the first codebook described in the case a2, the terminal device feeds back one or more bases based on W₁ and W₅, and feed back, based on W₄, one or more coefficients corresponding to the transmit-end space-domain and frequency-domain combined base matrix and the time-domain base matrix. In other words, the CSI fed back by the terminal device based on the first codebook described in the case a2 includes the one or more bases fed back based on W₁ and W₅, and the one or more coefficients that are fed back based on W₄ and that correspond to the transmit-end space-domain and frequency-domain combined base matrix and the time-domain base matrix. The foregoing information included in the CSI is merely an example, and the CSI further includes other information. This is not limited in at least one embodiment.

Operation 604: The network device reconstructs, based on the channel state information fed back by the terminal device and the first codebook, the channel present at the plurality of time points within the sounding duration, performs future channel prediction based on the channel present at the plurality of time points within the sounding duration, and determines a precoding matrix.

For example, in the case of the first codebook described in the case a1, in response to the network device reconstructing, based on the channel state information fed back by the terminal device and the first codebook, the channel present at the plurality of time points within the sounding duration, the network device reconstructs W₁, W₂, and W₃ based on the one or more bases fed back by the terminal device based on W₁ and W₃ and the one or more coefficients that are fed back by the terminal device based on W₂ and that correspond to the transmit-end space-domain and frequency-domain combined base matrix and the receive-end space-domain and time-domain combined base matrix, and perform a matrix operation based on W₁, W₂, and W₃, to reconstruct the channel present at the plurality of time points within the sounding duration.

For example, in the case of the first codebook described in the case a2, in response to the network device reconstructing, based on the channel state information fed back by the terminal device and the first codebook, the channel present at the plurality of time points within the sounding duration, the network device reconstructs W₁, W₄, and W₅ based on the one or more bases fed back by the terminal device based on W₁ and W₅ and the one or more coefficients that are fed back by the terminal device based on W₄ and that correspond to the transmit-end space-domain and frequency-domain combined base matrix and the time-domain base matrix, and perform a matrix operation based on W₁, W₄, and W₅, to reconstruct the channel present at the plurality of time points within the sounding duration.

According to the foregoing method, the first codebook includes the Doppler information. CSI expiration is essentially caused by a time-varying characteristic of a channel, and corresponds to Doppler variation. In a conventional technology, a network device keeps CSI unchanged within duration from last CSI reception to next CSI reception; however, a channel is time-varying within this duration, and therefore, the CSI is inconsistent with CSI of the time-varying channel. In at least one embodiment, the terminal device describes a time-varying characteristic of the channel by using the channel state information fed back based on the first codebook that includes the Doppler information. Changing of the Doppler information is slow within short sounding duration. Therefore, the network device predicts a future channel change trend by reconstructing, based on the first codebook, the channel present within the sounding duration. In this way, the network device predicts a channel present within duration from last CSI reception to next CSI reception, and perform precoding. Compared with the conventional technology in which CSI remains unchanged, in at least one embodiment, a channel change trend is predicted, and a downlink precoding matrix is calculated based on a predicted channel to better match a current channel, thereby improving system performance.

Further, transmit-end space-domain and frequency-domain combined and receive-end space-domain and time-domain combined bases are constructed, so that feedback coefficients obtained through projection of the channel on the base is sparser. In this way, fewer feedback coefficients are selected, thereby reducing feedback overheads. The channel state information is fed back in four dimensions, namely, a transmit end, a frequency domain, a receive end, and a time domain, or in three dimensions, namely, a transmit end, a frequency domain, and a time domain, so that a channel characteristic is represented more precisely. Therefore, the network device performs channel prediction more accurately based on the channel state information fed back by the terminal device.

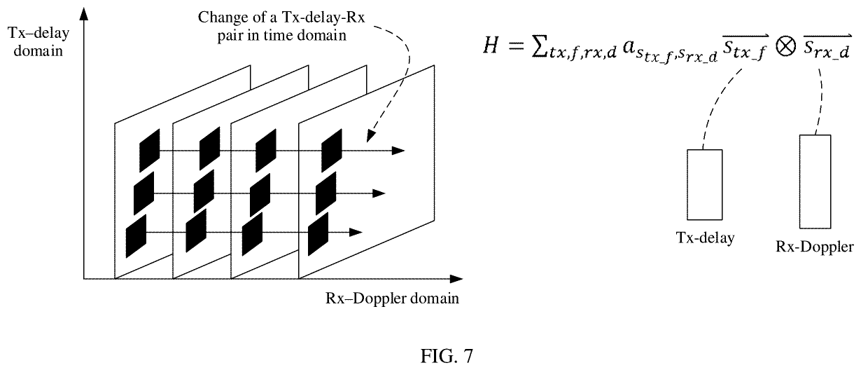

In a specific example, as shown in FIG. 7, the channel information within the sounding duration is projected to a transmit-end Tx and delay-domain (that is, frequency-domain) combined base and a receive-end Rx and Doppler-domain (that is, time-domain) combined base that are shown in the codebook, and a small quantity of feedback coefficients are selected. The terminal device reports the transmit-end Tx and delay-domain (that is, frequency-domain) combined base, the receive-end Rx and Doppler-domain (that is, time-domain) combined base, and channel projection coefficients in four dimensions, namely, the transmit end, the frequency domain, the receive end, and the time domain, based on the first codebook. The network device reconstructs, based on the fed-back channel information, the channel present within the sounding duration. The channel at the time points is represented by a plurality of Tx-delay-Rx pairs, and a subsequent channel is predicted based on a time-domain change of the Tx-delay-Rx pairs corresponding to the plurality of time points.

For example, for the codebook shown in FIG. 7, the channel H predicted by the network device meets the following formula 7:

$$H = {Σ}_{tx , f , rx , d} {a}_{{s}_{tx \_ f} , {s}_{rx \_ d}} \vec{{s}_{tx \_ f}} ⊗ \vec{{s}_{rx \_ d}} \qquad Formula 7$$

Herein,

$${Σ}_{tx , f , rx , d} {a}_{{s}_{tx \_ f} , {s}_{rx \_ d}}$$

represents a complex coefficient, [symbol] represents a transmit-end space-domain and frequency-domain combined base, [symbol] represents a receive-end space-domain and time-domain combined base, tx represents the transmit-end space domain, f represents the frequency domain, rx represents the receive-end space domain, and d represents the time domain.

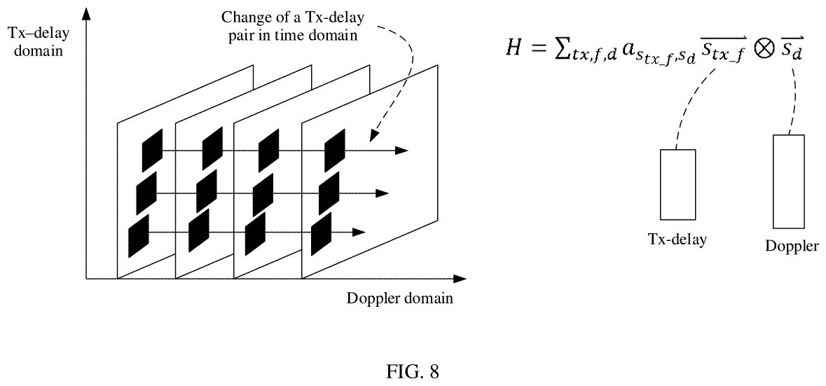

In another specific example, as shown in FIG. 8, the channel information within the sounding duration is projected to a transmit-end Tx and delay-domain (that is, frequency-domain) combined base and a Doppler-domain (that is, time-domain) base that are shown in the codebook, and a small quantity of feedback coefficients are selected. The terminal device reports the transmit-end Tx and delay-domain (that is, frequency-domain) combined base, the Doppler-domain (that is, time-domain) base, and channel projection coefficients in three dimensions, namely, the transmit end, the frequency domain, and the time domain, based on the first codebook. The network device reconstructs, based on the fed-back channel information, the channel present within the sounding duration. The channel at the time points is represented by a plurality of Tx-delay pairs, and a subsequent channel is predicted based on a time-domain change of the Tx-delay pairs corresponding to the plurality of time points.

For example, for the codebook shown in FIG. 8, the channel H predicted by the network device meets the following formula 8:

$$H = {Σ}_{tx , f , rx , d} {a}_{{s}_{tx \_ f} , {s}_{d}} \vec{{s}_{tx \_ f}} ⊗ \vec{{s}_{d}} \qquad Formula 8$$

Herein,

$${Σ}_{tx , f , rx , d} {a}_{{s}_{tx \_ f} , {s}_{d}}$$

represents a complex coefficient, [symbol] represents a transmit-end space-domain and frequency-domain combined base, [symbol] represents a time-domain base, tx represents the transmit-end space domain, f represents the frequency domain, and d represents the time domain.

Currently, during CSI feedback, a terminal device feeds back a base to a network device by using CSI. To increase CSI feedback coefficient sparsity, the terminal device performs channel projection usually by using a statistical covariance base. In addition, to reduce feedback overheads, the statistical covariance base is to be projected to a DFT base, and compressed and quantized to be fed back to the network device. In this case, the statistical covariance base represented by the DFT base is no longer orthogonal, and the terminal device performs an orthogonalization operation on the base. However, the network device obtains only a corresponding non-orthogonal base based on the CSI fed back by the terminal device and an existing codebook, and the non-orthogonal base is inconsistent with a base obtained through orthogonalization by the terminal device. In other words, the current codebook cannot implement alignment between the CSI base of the terminal device and the CSI base obtained by the network device based on the CSI fed back by the terminal device. As a result, the network device cannot accurately reconstruct a channel based on CSI feedback information. This affects accuracy of a precoding matrix.

Based on this, at least one embodiment provides another channel state information feedback method, to implement alignment between a CSI base obtained by a terminal device and a CSI base obtained by a network device.

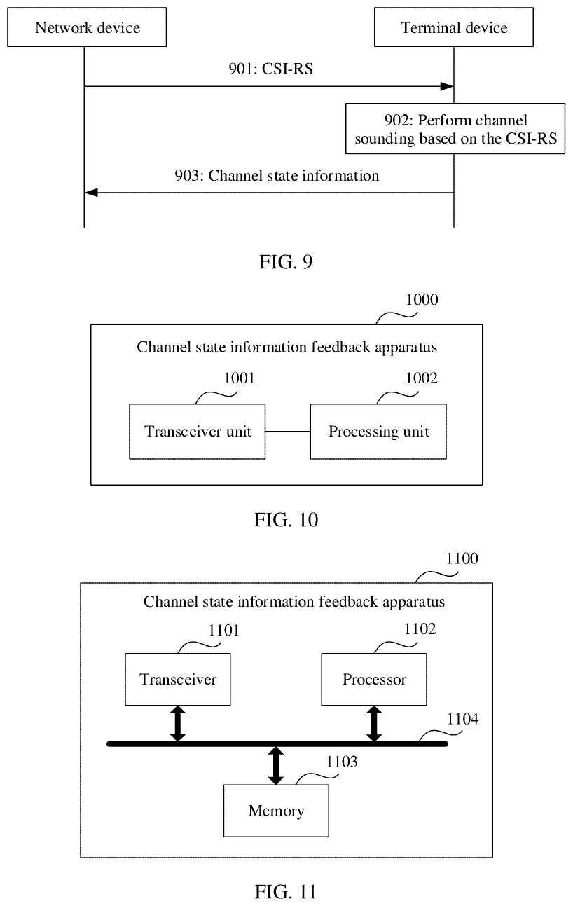

The another channel state information feedback method provided in at least one embodiment is applicable to the communications system shown in FIG. 1. Refer to FIG. 9. A specific procedure of the method includes the following operations:

Operation 901: A network device sends a CSI-RS to a terminal device, and correspondingly, the terminal device receives the CSI-RS from the network device.

Operation 902: The terminal device performs channel sounding based on the CSI-RS.

Operation 903: The terminal device feeds back channel state information to the network device, where the channel state information indicates one or more first bases, and the one or more first bases are used to generate, based on a preset base generation method, one or more second bases indicating the channel state information.

In at least one embodiment, a base is a vector used to represent a channel characteristic.

In an optional implementation, the one or more first bases are one or more space-domain and frequency-domain combined statistical covariance base column vectors obtained through quantization.

For example, the preset base generation method is an orthogonalization method, such as a QR decomposition method (also referred to as a Schmidt orthogonalization method), preconfigured or predefined by the network device.

Specifically, each of the terminal device and the network device generates, from the one or more first bases based on the preset base generation method, the one or more second bases indicating the channel state information, so that the base of the terminal device is aligned with the base of the network device.

According to the method, the base of the terminal device is aligned with the base of the network device, so that channel reconstruction and precoding is performed more accurately, thereby improving system performance

Based on the foregoing, at least one embodiment further provides a channel state information feedback apparatus. Refer to FIG. 10. The channel state information feedback apparatus 1000 includes a transceiver unit 1001 and a processing unit 1002. The transceiver unit 1001 is configured to receive a signal (information, a message, or data) or send a signal (information, a message, or data) for the channel state information feedback apparatus 1000. The processing unit 1001 is configured to control and manage an action of the channel state information feedback apparatus 1000. The processing unit 1001 further controls a operation performed by the transceiver unit 1001.

For example, the channel state information feedback apparatus 1000 is the terminal device in the foregoing embodiments, or a processor, a chip, a chip system, a functional module, or the like in the terminal device; or the channel state information feedback apparatus 1000 is the network device in the foregoing embodiments, or a processor, a chip, a chip system, a functional module, or the like in the network device.

In an embodiment, in response to the channel state information feedback apparatus 1000 being configured to implement a function of the terminal device in the embodiment described in FIG. 6, the following is included:

The transceiver unit 1001 is configured to receive a CSI-RS from a network device. The processing unit 1001 is configured to perform channel sounding based on the CSI-RS. The transceiver unit 1001 is further configured to feed back channel state information to the network device based on a first codebook, where the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

In an optional implementation, the first codebook meets the following formula:

W=W₁W₂W₃^{H}

Herein, W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix.

In another optional implementation, the first codebook meets the following formula:

W=W₁W₄W₅^{H}

Herein, W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix.

For example, the transmit-end space-domain and frequency-domain combined base matrix W₁ meets the following formula:

W₁=W₁₁W₁₂

Herein, W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

For example, the receive-end space-domain and time-domain combined base matrix W₃ meets the following formula:

W₃=W₃₁W₃₂

Herein, W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and sounding duration.

Optionally, one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

Specifically, W₁₁ meets the following formula:

W₁₁=W_{f}*⊗Wₜₓ

Herein, W_{f}* is a conjugate matrix of W_{f}, W_{f} indicates a frequency-domain basic base, and Wₜₓ indicates a transmit-end space-domain basic base.

Optionally, the frequency-domain basic base W_{f}and the transmit-end space-domain basic base Wₜₓ is DFT matrices.

Optionally, one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases.

Specifically, W₃₁ meets the following formula:

W₃₁=Wₜ*⊗Wᵣₓ

Herein, Wₜ* is a conjugate matrix of Wₜ, Wₜ indicates a time-domain basic base, and Wᵣₓ indicates a receive-end space-domain basic base.

Optionally, the time-domain basic base Wₜ and the receive-end space-domain basic base Wᵣₓ is DFT matrices.

In an example manner, a dimension of W₂ is L*N₁, L represents a selected quantity of transmit-end space-domain and frequency-domain combined bases, L is a value preconfigured or predefined by the network device, N₁ represents a selected quantity of receive-end space-domain and time-domain combined bases, and N₁ is a value preconfigured or predefined by the network device.

In an example manner, a dimension of W₄ is L*N_{d}, L represents a selected quantity of transmit-end space-domain and frequency-domain combined bases, L is a value preconfigured or predefined by the network device, and N_{d}represents sounding duration.

Optionally, a feedback period of the transmit-end space-domain and frequency-domain combined basic base correction matrix W₁₂ is T1, T1 is a value preconfigured or predefined by the network device, T1 is greater than a period of feeding back first information, and the first information is information other than information fed back based on W₁₂.

In an optional implementation, the transceiver unit 1001 is further configured to receive second information from the network device, where the second information indicates a codebook type used by the terminal device for channel sounding.

In an embodiment, in response to the channel state information feedback apparatus 1000 being configured to implement a function of the network device in the embodiment described in FIG. 6, the following is included:

The transceiver unit 1001 is configured to send a CSI-RS to a terminal device, and receive channel state information that is fed back by the terminal device based on a first codebook, where the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain. The processing unit 1001 is configured to control sending and receiving operations of the transceiver unit 1001. In an optional implementation, the first codebook meets the following formula:

W=W₁W₂W₃^{H}

Herein, W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix.

In another optional implementation, the first codebook meets the following formula:

W=W₁W₄W₅^{H}

Herein, W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix.

For example, the transmit-end space-domain and frequency-domain combined base matrix W₁ meets the following formula:

W₁=W₁₁W₁₂

Herein, W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

For example, the receive-end space-domain and time-domain combined base matrix W₃ meets the following formula:

W₃=W₃₁W₃₂

Herein, W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and sounding duration.

Optionally, one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

Specifically, W₁₁ meets the following formula:

W₁₁=W_{f}*⊗Wₜₓ

Herein, W_{f}* is a conjugate matrix of W_{f}, W_{f} indicates a frequency-domain basic base, and Wₜₓ indicates a transmit-end space-domain basic base.

Optionally, the frequency-domain basic base W_{f}and the transmit-end space-domain basic base Wₜₓ is DFT matrices.

Optionally, one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases. Specifically, W₃₁ meets the following formula:

W₃₁=Wₜ*⊗Wᵣₓ

Herein, Wₜ* is a conjugate matrix of Wₜ, Wₜ indicates a time-domain basic base, and W, indicates a receive-end space-domain basic base.

Optionally, the frequency-domain basic base W_{f} and the transmit-end space-domain basic base Wₜₓ is DFT matrices.

In an example, a dimension of W₂ is L*N₁, L represents a selected quantity of transmit-end space-domain and frequency-domain combined bases, L is a value preconfigured or predefined by the network device, N₁ represents a selected quantity of receive-end space-domain and time-domain combined bases, and N₁ is a value preconfigured or predefined by the network device.

In an example, a dimension of W₄ is L*N_{d}, L represents a selected quantity of transmit-end space-domain and frequency-domain combined bases, L is a value preconfigured or predefined by the network device, and N_{d} represents sounding duration.

Optionally, a feedback period of the transmit-end space-domain and frequency-domain combined basic base correction matrix W₁₂ is T1, T1 is a value preconfigured or predefined by the network device, T1 is greater than a period of feeding back first information, and the first information is information that is in the CSI and that is other than information fed back based on W₁₂.

For example, the transceiver unit 1001 is further configured to send second information to the terminal device, where the second information indicates a codebook type used by the terminal device for channel sounding.

In an embodiment, in response to the channel state information feedback apparatus 1000 being configured to implement a function of the terminal device in the embodiment described in FIG. 9, the following is included:

The transceiver unit 1001 is configured to receive a CSI-RS from a network device. The processing unit 1001 is configured to perform channel sounding based on the CSI-RS. The transceiver unit 1001 is further configured to feed back channel state information to the network device, where the channel state information indicates one or more first bases, and the one or more first bases are used to generate, based on a preset base generation method, one or more second bases indicating the channel state information.

For example, the one or more first bases is one or more space-domain and frequency-domain combined statistical covariance base column vectors obtained through quantization.

Optionally, the preset base generation method is an orthogonalization method preconfigured or predefined by the network device.

In an embodiment, in response to the channel state information feedback apparatus 1000 being configured to implement a function of the network device in the embodiment described in FIG. 9, the following is included:

The transceiver unit 1001 is configured to send a CSI-RS to a terminal device, and receive channel state information fed back by the terminal device, where the channel state information indicates one or more first bases, and the one or more first bases are used to generate, based on a preset base generation method, one or more second bases indicating the channel state information. The processing unit 1001 is configured to control operations of the transceiver unit 1001.

For example, the one or more first bases is one or more space-domain and frequency-domain combined statistical covariance base column vectors obtained through quantization.

Optionally, the preset base generation method is an orthogonalization method preconfigured or predefined by the network device.

Division into the units in embodiments described herein is an example, and is merely a logical function division. There is another division manner during actual implementation. Functional units in embodiments described herein is integrated into one processing unit, or each unit exists alone physically, or two or more units is integrated into one unit. The integrated unit is implemented in a form of hardware, or is implemented in a form of a software function unit.

In response to the integrated unit being implemented in the form of a software function unit and being sold or used as an independent product, the integrated unit is stored in a computer-readable storage medium. Based on such an understanding, the technical solutions in at least one embodiment essentially, or the part contributing to a conventional technology, or all or some of the technical solutions is implemented in a form of a software product. The computer software product is stored in a storage medium, and includes several instructions for instructing a computer device (which is a personal computer, a server, a network device, or the like) or a processor to perform all or some of the operations of the method in embodiments described herein. The foregoing storage medium includes any medium that stores program code, such as a USB flash drive, a removable hard disk, a read-only memory (ROM), a random access memory (RAM), a magnetic disk, or an optical disc.

Based on the foregoing, at least one embodiment further provides a channel state information feedback apparatus. Refer to FIG. 11. The channel state information feedback apparatus 1100 includes a transceiver 1101 and a processor 1102. Optionally, the channel state information feedback apparatus 1100 further includes a memory 1103. The memory 1103 is disposed inside the channel state information feedback apparatus 1100, or is disposed outside the channel state information feedback apparatus 1100. The processor 1102 controls the transceiver 1101 to receive and send information, signals, data, or the like.

Specifically, the processor 1102 is a central processing unit (CPU), a network processor (NP), or a combination of a CPU and an NP. The processor 1102 further includes a hardware chip. The hardware chip is an application-specific integrated circuit (ASIC), a programmable logic device (PLD), or a combination thereof. The PLD is a complex programmable logic device (CPLD), a field-programmable gate array (FPGA), a generic array logic (GAL), or any combination thereof.

The transceiver 1101, the processor 1102, and the memory 1103 are connected to each other. Optionally, the transceiver 1101, the processor 1102, and the memory 1103 are connected to each other by using a bus 1104. The bus 1104 is a peripheral component interconnect (PCI) bus, an extended industry standard architecture (EISA) bus, or the like. The bus is classified into an address bus, a data bus, a control bus, and the like. For ease of representation, in FIG. 11, only one bold line is used to represent the bus. However, this does not indicate that there is only one bus or one type of bus.

In an optional implementation, the memory 1103 is configured to store a program or the like. Specifically, the program includes program code, and the program code includes computer operation instructions. The memory 1103 includes a RAM, and further includes a non-volatile memory, for example, one or more magnetic disk memories. The processor 1102 executes the application program stored in the memory 1103, to implement the foregoing function, thereby implementing a function of the channel state information feedback apparatus 1100.

For example, the channel state information feedback apparatus 1100 is the terminal device in the foregoing embodiments, or is the network device in the foregoing embodiments.

In an embodiment, in response to the channel state information feedback apparatus 1100 implementing a function of the terminal device in the embodiment shown in FIG. 6, the transceiver 1101 implements receiving and sending operations performed by the terminal device in the embodiment shown in FIG. 6, and the processor 1102 implements an operation, other than the receiving and sending operations, performed by the terminal device in the embodiment shown in FIG. 6. For specific related descriptions, refer to related descriptions in the embodiment shown in FIG. 6. Details are not described herein again.

In another embodiment, in response to the channel state information feedback apparatus 1100 implementing a function of the network device in the embodiment shown in FIG. 6, the transceiver 1101 implements receiving and sending operations performed by the network device in the embodiment shown in FIG. 6, and the processor 1102 implements an operation, other than the receiving and sending operations, performed by the network device in the embodiment shown in FIG. 6. For specific related descriptions, refer to related descriptions in the embodiment shown in FIG. 6. Details are not described herein again.

In another embodiment, in response to the channel state information feedback apparatus 1100 implementing a function of the terminal device in the embodiment shown in FIG. 9, the transceiver 1101 implements receiving and sending operations performed by the terminal device in the embodiment shown in FIG. 9, and the processor 1102 implements an operation, other than the receiving and sending operations, performed by the terminal device in the embodiment shown in FIG. 9. For specific related descriptions, refer to related descriptions in the embodiment shown in FIG. 9. Details are not described herein again.

In another embodiment, in response to the channel state information feedback apparatus 1100 implementing a function of the network device in the embodiment shown in FIG. 9, the transceiver 1101 implements receiving and sending operations performed by the network device in the embodiment shown in FIG. 9, and the processor 1102 implements an operation, other than the receiving and sending operations, performed by the network device in the embodiment shown in FIG. 9. For specific related descriptions, refer to related descriptions in the embodiment shown in FIG. 9. Details are not described herein again.

Based on the foregoing, at least one embodiment provides a communications system. The communications system includes the terminal device, the network device, and the like in the foregoing embodiments.

At least one embodiment further provides a computer-readable storage medium. The computer-readable storage medium is configured to store a computer program. In response to the computer program being executed by a computer, the computer implements the channel state information feedback method provided in the foregoing method embodiments.

At least one embodiment further provides a computer program product. The computer program product is configured to store a computer program. In response to the computer program being executed by a computer, the computer implements the channel state information feedback method provided in the foregoing method embodiments.

At least one embodiment further provides a chip including a processor. The processor is coupled to a memory, and is configured to invoke a program in the memory, so that the chip implements the channel state information feedback method provided in the foregoing method embodiments.

At least one embodiment further provides a chip. The chip is coupled to a memory, and the chip is configured to implement the channel state information feedback method provided in the foregoing method embodiments.

A person skilled in the art should understand that embodiments described herein is provided as a method, a system, or a computer program product. Therefore, at least one embodiment uses a form of a hardware-only embodiment, a software-only embodiment, or an embodiment with a combination of software and hardware. In addition, at least one embodiment uses a form of a computer program product implemented on one or more computer-usable storage media (including but not limited to a magnetic disk memory, a CD-ROM, an optical memory, and the like) that include computer-usable program code.

At least one embodiment is described with reference to the flowcharts and/or block diagrams of the method, the device (system), and the computer program product according to at least one embodiment. Each procedure and/or block in the flowcharts and/or block diagrams, and combinations of procedures and/or blocks in the flowcharts and/or block diagrams is implemented by using computer program instructions. These computer program instructions is provided to a general-purpose computer, a special-purpose computer, an embedded processor, or a processor of another programmable data processing device, to generate a machine, so that the instructions executed by the computer or the processor of another programmable data processing device generate an apparatus for implementing a specified function in one or more procedures in the flowchart and/or one or more blocks in the block diagram.

Alternatively, these computer program instructions is stored in a computer-readable memory that instructs a computer or another programmable data processing device to work in a specific manner, so that the instructions stored in the computer-readable memory generate an artifact including an instruction apparatus. The instruction apparatus implements a specified function in one or more procedures in the flowchart and/or one or more blocks in the block diagram.

Alternatively, these computer program instructions is loaded to a computer or another programmable data processing device, so that a series of operation operations are performed on the computer or the another programmable device, to generate computer-implemented processing, so that the instructions executed on the computer or the another programmable device provide a operation for implementing a specified function in one or more procedures in the flowchart and/or one or more blocks in the block diagram.

A person skilled in the art is able to make various modifications and variations to embodiments described herein without departing from the scope of at least one embodiment. Therefore, at least one embodiment is intended to cover these modifications and variations provided that these modifications and variations fall within the scope of the claims and equivalent technologies thereof.

1. A channel state information feedback method, comprising:
receiving, by a terminal device, a channel state information reference signal (CSI-RS) from a network device;
performing channel sounding based on the CSI-RS; and
feeding back, by the terminal device, channel state information (CSI) to the network device based on a first codebook, wherein the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

2. The method according to claim 1, wherein the feeding back, by the terminal device, the channel state information (CSI) to the network device based on the first codebook includes feeding back the channel state information (CSI) to the network device based on the first codebook that meets the following formula:
W=W₁W₂W₃^{H}, wherein
W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix.

3. The method according to claim 1, wherein the feeding back, by the terminal device, the channel state information (CSI) to the network device based on the first codebook includes feeding back the channel state information (CSI) to the network device based on the first codebook that meets the following formula:
W=W₁W₄W₅^{H}, wherein
W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix.

4. The method according to claim 2, wherein the feeding back the channel state information (CSI) to the network device based on the first codebook includes feeding back the channel state information (CSI) to the network device based on the first codebook, wherein W is the first codebook, and W₁ is transmit-end space-domain and frequency-domain combined base matrix W₁ that meets the following formula:
W₁=W₁₁W₁₂, wherein
W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

5. The method according to claim 2, wherein the feeding back the channel state information (CSI) to the network device based on the first codebook, includes feeding back the channel state information (CSI) to the network device based on the first codebook, wherein W is the first codebook, and W₃ is the receive-end space-domain and time-domain combined base matrix W₃ that meets the following formula:
WW₃=W₃₁W₃₂, wherein
W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and sounding duration.

6. The method according to claim 3, wherein feeding back the channel state information (CSI) to the network device based on the first codebook includes feeding back the channel state information (CSI) to the network device based on the first codebook, wherein W is the first codebook, and W₁ is the transmit-end space-domain and frequency-domain combined base matrix W₁ that meets the following formula:
W₁=W₁₁W₁₂, wherein
W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

7. The method according to claim 4, wherein the feeding back the channel state information (CSI) to the network device based on the first codebook includes feeding back the channel state information (CSI) to the network device based on the first codebook, wherein W is the first codebook, and W₁ is transmit-end space-domain and frequency-domain combined base matrix W₁, wherein one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined basic base matrix corresponds to a plurality of frequency-domain basic bases.

8. The method according to claim 6, wherein the feeding back the channel state information (CSI) to the network device based on the first codebook includes feeding back the channel state information (CSI) to the network device based on the first codebook, wherein W is the first codebook, and W₁ is transmit-end space-domain and frequency-domain combined base matrix W₁, wherein one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined basic base matrix corresponds to a plurality of frequency-domain basic bases.

9. The method according to claim 5, wherein the feeding back the channel state information (CSI) to the network device based on the first codebook includes feeding back the channel state information (CSI) to the network device based on the first codebook, wherein W is the first codebook, and W₃ is the receive-end space-domain and time-domain combined base matrix, wherein one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases.

10. A terminal device, comprising:
at least one processor;
at least one memory configured to store a computer program that, when executed by the at least one processor, causes the communication apparatus to:
receive a channel state information reference signal (CSI-RS) from a network device;
perform channel sounding based on the CSI-RS; and
feed back channel state information (CSI) to the network device based on a first codebook, wherein the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

11. The terminal device according to claim 10, wherein the first codebook meets the following formula:
W=W₁W₂W₃^{H}, wherein
W is the first codebook, W₁ is a transmit-end space-domain and frequency-domain combined base matrix, the transmit-end space-domain and frequency-domain combined base matrix includes the one or more transmit-end space-domain and frequency-domain column vectors, W₃ is a receive-end space-domain and time-domain combined base matrix, the receive-end space-domain and time-domain combined base matrix includes the one or more receive-end space-domain and time-domain column vectors, and W₂ is a complex coefficient matrix corresponding to the transmit-end space-domain and frequency-domain combined base matrix and the receive-end space-domain and time-domain combined base matrix.

12. The terminal device according to claim 10, wherein the first codebook meets the following formula:
W=W₁W₄W₅^{H}, wherein
W is the first codebook, W₁ is a transmit-end space-domain and frequency-domain combined base matrix, the transmit-end space-domain and frequency-domain combined base matrix includes the one or more transmit-end space-domain and frequency-domain column vectors, W₅ is a time-domain base matrix, the time-domain base matrix includes the one or more time-domain column vectors, and W₄ is a complex coefficient matrix corresponding to the transmit-end space-domain and frequency-domain combined base matrix and the time-domain base matrix.

13. The terminal device according to claim 11, wherein the transmit-end space-domain and frequency-domain combined base matrix W₁ meets the following formula:
W₁=W₁₁W₁₂, wherein
W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

14. The terminal device according to claim 11, wherein the receive-end space-domain and time-domain combined base matrix W₃ meets the following formula:
W₃=W₃₁W₃₂, wherein
W₃₁ is a receive-end space-domain and time-domain combined basic base matrix, each column vector in W₃₁ corresponds to one receive-end space-domain and time-domain combined basic base, W₃₂ is a receive-end space-domain and time-domain combined basic base correction matrix, and a column vector length of W₃₁ is related to a quantity of antennas of the terminal device and sounding duration.

15. The terminal device according to claim 12, wherein the transmit-end space-domain and frequency-domain combined base matrix W₁ meets the following formula:
W₁=W₁₁W₁₂, wherein
W₁₁ is a transmit-end space-domain and frequency-domain combined basic base matrix, each column vector in W₁₁ corresponds to one transmit-end space-domain and frequency-domain combined basic base, W₁₂ is a transmit-end space-domain and frequency-domain combined basic base correction matrix, and a column vector length of W₁₁ is related to a quantity of antennas of the network device and a quantity of frequency-domain resource units occupied by the CSI-RS.

16. The terminal device according to claim 13, wherein one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

17. The terminal device according to claim 15, wherein one frequency-domain basic base in the transmit-end space-domain and frequency-domain combined basic base matrix corresponds to a plurality of transmit-end space-domain basic bases, or one transmit-end space-domain basic base in the transmit-end space-domain and frequency-domain combined base matrix corresponds to a plurality of frequency-domain basic bases.

18. The terminal device according to claim 14, wherein one time-domain basic base in the receive-end space-domain and time-domain combined basic base matrix corresponds to a plurality of receive-end space-domain basic bases, or one receive-end space-domain basic base in the receive-end space-domain and time-domain combined base matrix corresponds to a plurality of time-domain basic bases.

19. A non-transitory computer-readable storage medium, wherein the non-transitory computer-readable storage medium stores computer-executable instructions, and when the computer-executable instructions are invoked by a computer, the computer-executable instructions are used to enable the computer to perform operations comprising:
receiving a channel state information reference signal (CSI-RS) from a network device, and performing channel sounding based on the CSI-RS; and
feeding back channel state information (CSI) to the network device based on a first codebook, wherein the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.

20. A chip, wherein the chip is coupled to a memory, and is configured to read and execute program instructions stored in the memory, to perform operations comprising:
receiving a channel state information reference signal (CSI-RS) from a network device, and performing channel sounding based on the CSI-RS; and
feeding back channel state information (CSI) to the network device based on a first codebook, wherein the first codebook is determined based on one or more transmit-end space-domain and frequency-domain column vectors and one or more receive-end space-domain and time-domain column vectors that represent a channel, or the first codebook is determined based on the one or more transmit-end space-domain and frequency-domain column vectors and one or more time-domain column vectors that represent the channel, the one or more transmit-end space-domain and frequency-domain column vectors indicate channel information in a combination of a transmit-end space domain and frequency domain, and the one or more receive-end space-domain and time-domain column vectors indicate channel information in a combination of a receive-end space domain and time domain.
